(19) United States
(12) Patent Application Publication
(10) Pub. No.: US 2025/0053150 A1
(43) Pub. Date: Feb. 13, 2025

(54) SIMULATION DEVICE FOR ROBOT OR MACHINE TOOL

(71) Applicant: Fanuc Corporation, Yamanashi (JP)

(72) Inventor: Yuuki KIMOTO, Minamitsuru-gun, Yamanashi (JP)

(73) Assignee: Fanuc Corporation, Yamanashi (JP)

(21) Appl. No.: 18/721,715

(22) PCT Filed: Dec. 27, 2021
(86) PCT No.: PCT/JP2021/048684

§ 371 Date: Jun. 19, 2024

(51) Int. Cl. G05B 19/4069; B25J 9/16

(52) U.S. Cl. CPC G05B 19/4069; B25J 9/1671; G05B 2219/32398; G05B 2219/34457

(57) ABSTRACT

This simulation device includes a simulation unit which performs simulation of the motion of a robot or a machine tool; a settings alteration unit which, in the case of occurrence of an alarm indicating an anomaly in the motion of the robot or the machine tool during simulation, alters settings information data to be used to control the motion of the robot or the machine tool; and an option deletion unit which, in the case of occurrence of the alarm, deletes option software to be used to control option functionality included in the motion of the robot or the machine tool.

### CROSS REFERENCE TO RELATED APPLICATIONS

This is the U.S. National Phase of PCT/JP2021/048684, filed Dec. 27, 2021, the disclosures of this application being incorporated herein by reference in their entireties for all purposes.

### FIELD OF THE INVENTION

The present invention relates to a simulation device for a robot or a machine tool.

### BACKGROUND OF THE INVENTION

A simulation device performing off-line simulation of the operation of an industrial robot or a machine tool is known.

For example, PTL 1 describes a robot simulation device performing a simulation of the operation of a system in which an actual robot and actual peripheral equipment are combined, by displaying the operation of the robot and the peripheral equipment on a screen by a dynamic image, the robot simulation device including an information processing device and a robot controller for controlling the actual robot that are connected by a communication channel, wherein robot operation position information from the robot controller and command information output to the peripheral equipment are transmitted to the information processing device through the communication channel, and the operation of the robot and the peripheral equipment is displayed by way of a dynamic image, based on the robot operation position information and the command information.

For example, PTL 2 describes a robot system that can reproduce a state in which an alarm is issued, the robot system including a robot and a simulation device being connected to the robot by a communication line and performing a simulation of the operation of the robot, wherein the robot includes a means for, when a predefined alarm is issued in the robot in operation, recording the operation status at that time as robot history information and a means for transferring the robot history information to the simulation device through the communication line, and the simulation device includes a means for receiving the robot history information transferred from the robot and a means for reproducing the operation status of the robot at the time of issuance of the alarm by a simulation by using the received robot history information.

### PATENT LITERATURE

[PTL 1]JP 2003-117863A
[PTL 2]JP 2005-103681A

### SUMMARY OF THE INVENTION

When the environment in which the actual robot is installed differs from the virtual environment on the robot simulation device, the issuance of some type of alarm may occur in the robot on the simulation device. When an alarm is issued, an operator needs to check the content of the alarm and manually perform, for example, a change of a setting of the robot or deletion of an optional function of the robot, as necessary. However, clearance of the alarm may take time. The aforementioned issue may similarly occur in a simulation device for a machine tool. Accordingly, a simulation device for a robot or a machine tool that can easily clear an alarm is desired.

According to an aspect of the present disclosure, a simulation device includes: a simulation unit configured to perform a simulation of operation of a robot or a machine tool; a setting change unit configured to change setting information data used when operation of the robot or the machine tool is controlled, when an alarm indicating abnormal operation of the robot or the machine tool is issued in a simulation performed by the simulation unit; and an option deletion unit configured to delete optional software used when an optional function in operation of the robot or the machine tool is controlled, when the alarm is issued.

According to the aspect of the present disclosure, an alarm can be easily cleared in a simulation device for a robot or a machine tool.

### BRIEF DESCRIPTION OF DRAWINGS

FIG. 1 is a block diagram illustrating a simulation device according to an embodiment of the present disclosure.

FIG. 2 is a diagram illustrating a system configuration example of the simulation device according to the embodiment of the present disclosure.

FIG. 3 is a flowchart illustrating a flow of each type of processing in the simulation device according to the embodiment of the present disclosure.

FIG. 4 is a flowchart illustrating alarm clearance determination processing at setting information data change in the simulation device according to the embodiment of the present disclosure.

FIG. 5 is a flowchart illustrating check processing in the simulation device according to the embodiment of the present disclosure.

### DETAILED DESCRIPTION OF EMBODIMENTS OF THE INVENTION

A simulation device for a robot or a machine tool will be described below with reference to the drawings. In each drawing, similar components are given similar reference signs. For ease of understanding, the drawings use different scales, as appropriate. Illustrated configurations are examples for implementation, and the simulation device is not limited to the illustrated configurations.

A standard function of an industrial robot or a machine tool is controlled in accordance with previously introduced (implemented) “standard software.” Further, a robot or a machine tool is highly flexible, is applicable to various uses, and may further extend a function or change a function by using specific connected equipment according to the purpose. Such a function extended or changed ex-post is also referred to as an “optional function” or an “extended function.” For example, an optional function of a robot or a machine tool is controlled in accordance with “optional software” additionally introduced (implemented) after factory shipment. Further, a unique optional function may be required for each user (customer) even for the same type of use, and introduction of optional software dedicated to each user is preferred in such a case.

A simulation device according to the embodiment of the present disclosure is a robot simulation device performing a simulation of the operation of a robot or a machine tool simulation device performing a simulation of the operation of a machine tool. While a robot simulation device (simply referred to as a “simulation device”) will be described as an example, the following description is similarly applicable to a machine tool simulation device.

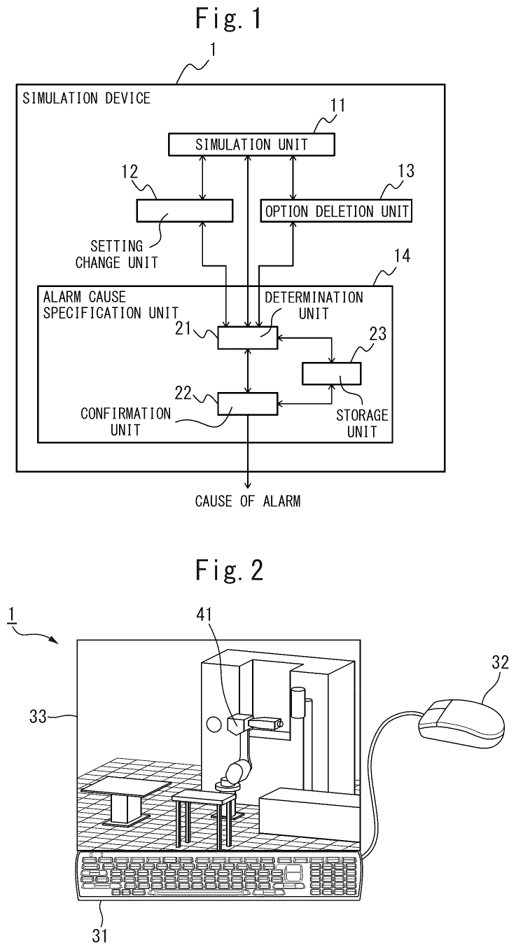

FIG. 1 is a block diagram illustrating the simulation device according to the embodiment of the present disclosure. FIG. 2 is a diagram illustrating a system configuration example of the simulation device according to the embodiment of the present disclosure.

For example, the simulation device 1 is a computer including an input device including a keyboard 31 and a mouse 32, a display device 33, and an arithmetic processing unit (unillustrated), as illustrated in FIG. 2. Software similar to software for controlling a standard function of an actual robot and software similar to optional software for controlling an optional function are installed on the simulation device 1. Further, data similar to setting information data defining various settings used when the operation of the actual robot is controlled are input to the simulation device 1. The simulation device 1 performs a simulation reproducing the operation of a robot 41 in a virtual space by using the standard software and the optional software, and the setting information data and displays the simulation result on a screen of the display device 33.

There are several tens to several hundreds of types of optional software used when the operation of a robot is controlled. While examples of optional software include each type of optional software for controlling each type of specific connected equipment in the robot, optional software for causing an arm of the robot to perform a special movement, optional software for causing the body (base) of the robot to perform special movement, another type of optional software may also be included. While examples of optional software for controlling specific connected equipment in the robot include optional software for controlling a specific hand attached to the robot, optional software for controlling a specific tool attached to the robot, optional software for controlling a specific camera attached to the robot, optional software for controlling a specific sensor attached to the robot, and optional software for controlling specific communication equipment attached to the robot, another type of optional software may also be included.

Setting information data used when the operation of the robot is controlled are data defining information about various settings of a standard function controlled by the standard software and an optional function controlled by optional software; and while for example, setting information related to setting information related to a supply voltage of connected equipment, setting information related to communication with the connected equipment, setting information related to a coordinate system of the robot, setting information related to a load, and other types of setting information are defined, setting information other than the above may be defined by the setting information data.

Similarly, there are several tens to several hundreds of types of optional software used when the operation of a machine tool is controlled. While examples of optional software include each piece of optional software for controlling each of specific connected equipment in the machine tool, optional software related to axis control of the machine tool, and optional software for causing a numeric controller in the machine tool to execute specific arithmetic processing, another type of optional software may also be included. Examples of optional software related to axis control of the machine tool include optional software related to an extended function of the controlled number of axes and optional software related to feed rod synchronization control, and examples of optional software for causing a numeric controller in the machine tool to execute specific arithmetic processing include optional software related to cylindrical interpolation processing.

While examples of setting information data used when the operation of a machine tool is controlled include setting information related to supply voltage to connected equipment, setting information related to communication with the connected equipment, setting information related to a coordinate system used for axis control in the machine tool, setting information related to a load, and other types of setting information, setting information other than the above may be defined by the setting information data.

As illustrated in FIG. 1, the simulation device 1 includes a simulation unit 11, a setting change unit 12, and an option deletion unit 13. The simulation device 1 further includes an alarm cause specification unit 14.

The simulation unit 11 is configured to perform a simulation of reproducing the operation of the robot in a virtual space by using the standard software and optional software, and setting information data. When some abnormal operation occurs in the robot during a simulation performed by the simulation unit 11, an alarm is issued.

The setting change unit 12 is configured to change setting information data used when the operation of the robot is controlled, when an alarm is issued in a simulation performed by the simulation unit 11.

The option deletion unit 13 is configured to delete (uninstall) optional software used when an optional function in the operation of the robot is controlled, when an alarm is issued in a simulation performed by the simulation unit 11.

When setting information data changed by the setting change unit 12 and/or optional software deleted by the option deletion unit 13 is a cause of an alarm, the alarm is cleared. The alarm cause specification unit 14 is configured to specify the cause of the alarm, based on the content of the change of the setting information data by the setting change unit 12 and/or the content of the deletion of the optional software by the option deletion unit 13. The alarm cause specification unit 14 includes a determination unit 21, a confirmation unit 22, and a storage unit 23. The determination unit 21 is configured to determine whether the alarm is cleared at change of the setting information data by the setting change unit 12 and/or at deletion of the optional software by the option deletion unit 13. The confirmation unit 22 is configured to confirm setting information data changed when the determination unit 21 determines that an alarm is cleared and/or optional software deleted when the determination unit 21 determines that an alarm is cleared as a cause of the alarm. The cause of the alarm confirmed by the confirmation unit 22 is displayed on a screen of the display device 33. The storage unit 23 is configured to store alarm history information associating setting information data and/or optional software confirmed as a cause of an alarm by the confirmation unit 22 with the alarm.

The alarm history information is accumulated in the storage unit 23 each time an alarm is issued in a simulation performed by the simulation unit 11 and is referred to when which setting information data are to be changed by the setting change unit 12 and which optional software is to be deleted by the option deletion unit 13 when an alarm is issued the next time or later are determined. In other words, when an alarm is issued in a simulation performed by the simulation unit 11, the setting change unit 12 refers to past alarm history information stored in the storage unit 23 and preferentially changes the same data as setting information data recorded as alarm history information related to the alarm. For example, when setting information data A input to the simulation device 1 are ON, setting information data B are OFF, and setting information data C are ON and alarm clearance by the setting information data A being OFF, the setting information data B being OFF, and the setting information data C being OFF is recorded as alarm history information, the setting change unit 12 refers to the alarm history information and executes three types of setting change processing being “the setting information data A are OFF, and the setting information data C are ON,” “the setting information data A are ON, and the setting information data C are OFF,” and “the setting information data A are OFF, and the setting information data C are OFF.” When an issued alarm is new, the alarm is not included in the alarm history information, and therefore in that case, the setting change unit 12 changes setting information data not yet included in the alarm history information. Further, when an alarm is issued in a simulation performed by the simulation unit 11, the option deletion unit 13 refers to the past alarm history information stored in the storage unit 23 and preferentially deletes the same optional software as optional software recorded as alarm history information related to the alarm. When an issued alarm is new, the alarm is not included in the alarm history information, and therefore in that case, the option deletion unit 13 changes optional software not included in the alarm history information.

According to the embodiment of the present disclosure, when an alarm is issued in a simulation performed by the simulation unit 11, the setting change unit 12 changes setting information data, and the determination unit 21 determines whether the change of the setting information data clears the alarm in the simulation. When the setting change unit 12 changes setting information data with issuance of an alarm in a simulation performed by the simulation unit 11 and the determination unit 21 still does not determine that the alarm is cleared, the option deletion unit 13 deletes optional software. When the determination unit 21 still does not determine that the alarm is cleared after the option deletion unit 13 deletes the optional software, the setting change unit 12 further changes setting information data.

When the option deletion unit 13 deletes a piece of optional software (for example, first optional software), the determination unit 21 does not determine that the alarm is cleared, the option deletion unit 13 subsequently further deletes another piece of optional software (for example, second optional software), and the determination unit 21 determines that the alarm is cleared in a process of repetition of the aforementioned processing, the alarm is cleared by deletion of a plurality of pieces of optional software (i.e., the first optional software and the second optional software). In this case, while the second optional software deleted at the end is highly likely to be the cause of the alarm, the second optional software alone may not be the cause of the alarm. For example, there may be some relation between the first optional software and the second optional software; and the second optional software alone may not be the cause of the alarm, but simultaneous implementation of the first optional software and the second optional software may be the cause of the alarm. Further, for example, when three alarms are simultaneously issued and the alarms are cleared by deletion of three pieces of optional software, whether all of the three pieces of optional software are the cause of the alarms, two of the three pieces of optional software are the cause of the alarms, or one piece of optional software deleted at the end is the cause of the alarms cannot be distinguished. Further, for example, when one alarm is issued, the alarm may be cleared by deletion of optional software, but another alarm may be newly issued by deletion of the optional software; and in this case, the cause of the alarm cannot be confirmed.

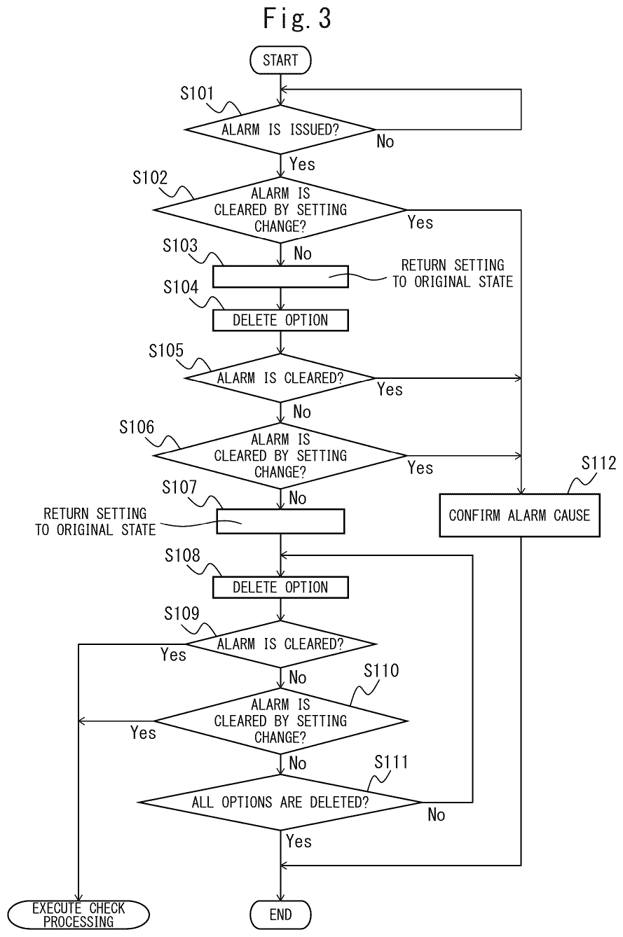

Then, when an alarm is cleared by deletion of the plurality of pieces of optional software, the option deletion unit 13 deletes the second optional software again in a state of the first optional software and the second optional software being re-added, and the determination unit 21 at that point determines whether the alarm is cleared in the simulation by deletion of the second optional software by the option deletion unit 13, as check processing. Such processing is repeatedly executed until the determination unit 21 determines that the alarm is cleared. A series of processing operations until specification of the cause of the alarm is reached in the simulation device according to the embodiment of the present disclosure will be described in more detail with reference to FIG. 3 to FIG. 5.

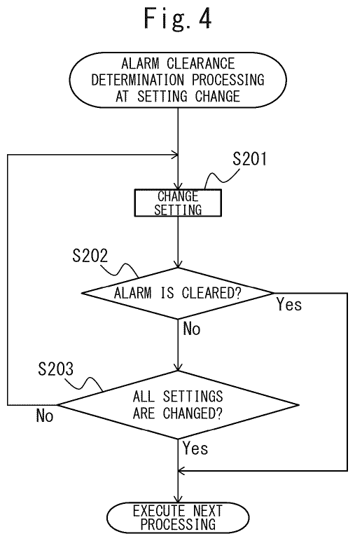

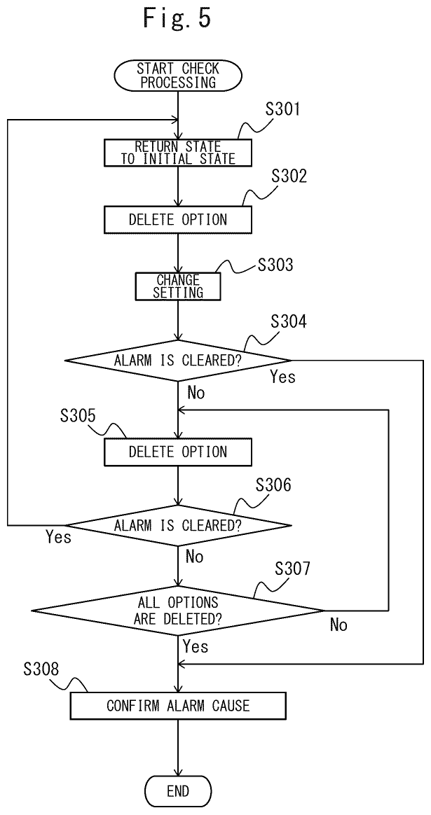

FIG. 3 is a flowchart illustrating a flow of each type of processing in the simulation device according to the embodiment of the present disclosure. FIG. 4 is a flowchart illustrating alarm clearance determination processing at change of setting information data in the simulation device according to the embodiment of the present disclosure. FIG. 5 is a flowchart illustrating the check processing in the simulation device according to the embodiment of the present disclosure. Each type of processing described below is executed when the simulation unit 11 performs a simulation of reproducing the operation of the robot in a virtual space.

In step S101, the alarm cause specification unit 14 determines whether an alarm is issued by a simulation performed by the simulation unit 11. When an alarm is determined to be issued in step S101, the alarm clearance determination processing at setting change is executed in step S102.

In step S102, the determination unit 21 determines whether the alarm is cleared in the simulation performed by the simulation unit 11 by change of setting information data by the setting change unit 12.

The alarm clearance determination processing at setting change in step S102, and steps S106 and S110 to be described later will be described in more detail with reference to FIG. 4.

As illustrated in FIG. 4, in step S201, the setting change unit 12 executes change processing of setting information data, and the simulation unit 11 executes a simulation; and next, in step S202, the determination unit 21 determines whether the alarm is cleared in the simulation. When the alarm is not determined to be cleared in step S202 (i.e., when the alarm is not cleared), the processing advances to step S203.

In step S203 in FIG. 4, the setting change unit 12 determines whether the change processing is executed on all pieces of setting information data and conceivable combinations of the pieces of setting information data. At that time, the setting change unit 12 refers to the past alarm history information stored in the storage unit 23 and preferentially changes the same setting information data as setting information data recorded as alarm history information related to the alarm. When setting information data or a combination including the data on which the change processing is not executed are determined to exist in step S203, the processing returns to step S201, and the setting change unit 12 selects change processing from setting information data or a combination including the data on which change processing is not executed and executes the processing. While a plurality of pieces of setting information data exist, taking an example of two types existing as setting information data A and setting information data B, there are a total of three types of change processing executed in step 201 being independent change processing of the setting information data A, independent change processing of the setting information data B, and simultaneous change processing of both pieces of the setting information data A and B. Step S203 is for examining whether change processing not yet being executed out of the three types of change processing exists. For example, when the setting change unit 12 changes the setting information data A in step S201, and the alarm is determined to be cleared in the simulation performed by the simulation unit 11 in next step S202, the alarm clearance determination processing at setting registration is ended at that point, and the processing advances to the next processing. Further, for example, when the setting change unit 12 changes the setting information data A in step S201, and the alarm is not determined to be cleared in the simulation performed by the simulation unit 11 in next step S202, the processing returns to step S201 through step S203; and the setting change unit 12 changes the setting information data B, and when the alarm is determined to be cleared in the simulation performed by the simulation unit 11 in next step S202, the alarm clearance determination processing at setting registration is ended at that point, and the processing advances to the next processing. Further, for example, when the setting change unit 12 changes the setting information data A in step S201, the alarm is not determined to be cleared in the simulation performed by the simulation unit 11 in next step S202, the processing returns to step S201 through step S203, the setting change unit 12 changes the setting information data B, and the alarm is still not determined to be cleared in the simulation performed by the simulation unit 11 in next step S202, then the processing returns to step S201 through step S203, the setting change unit 12 changes both the setting information data A and B, and whether the alarm is cleared in the simulation performed by the simulation unit 11 is determined in step S202. When the change processing is determined to be executed on all pieces of setting information data and conceivable combinations of the pieces of setting information data in step S203, the alarm clearance determination processing at setting registration is ended at that point, and the processing advances to the next processing.

When the alarm is determined to be cleared in the simulation performed by the simulation unit 11 through the alarm clearance determination processing at setting registration in step S102, in step S112, the determination unit 21 confirms the setting information data changed in step S102 to be the cause of the alarm, and the storage unit 23 stores alarm history information associating the setting information data confirmed to be the cause of the alarm by the confirmation unit 22 with the alarm.

When the alarm is not determined to be cleared in the simulation performed by the simulation unit 11 through the alarm clearance determination processing at setting registration in step S102, the processing advances to step S103.

The setting information data changed in step S102 are returned to the state before the change (returned to the original state) in step S103.

In step S104, the option deletion unit 13 deletes one of the implemented pieces of optional software. At that time, the option deletion unit 13 refers to the past alarm history information stored in the storage unit 23 and preferentially deletes the same optional software as optional software recorded as alarm history information related to the alarm.

In step S105, the determination unit 21 determines whether the alarm is cleared in the simulation performed by the simulation unit 11 by deletion of the optional software in step S104. When the alarm is not determined to be cleared in step S105, the processing advances to step S106. When the alarm is determined to be cleared in step S105, in step S112, the determination unit 21 confirms the optional software deleted in step S104 to be the cause of the alarm, and the storage unit 23 stores alarm history information associating the optional software confirmed to be the cause of the alarm by the confirmation unit 22 with the alarm.

In step S106, the alarm clearance determination processing at setting change described with reference to FIG. 4 is executed. In other words, the determination unit 21 determines whether the alarm is cleared in the simulation performed by the simulation unit 11 by change of setting information data by the setting change unit 12.

When the alarm is not determined to be cleared in the simulation performed by the simulation unit 11 through the alarm clearance determination processing at setting registration in step S106, the processing advances to step S107.

When the alarm is determined to be cleared in the simulation performed by the simulation unit 11 through the alarm clearance determination processing at setting registration in step S106, in step S112, the determination unit 21 confirms the setting information data changed in step S106 and the optional software deleted in step S104 to be the cause of the alarm, and the storage unit 23 stores alarm history information associating the setting information data and the optional software that are confirmed to be the cause of the alarm by the confirmation unit 22 with the alarm.

In step S107, the setting is returned to the original state by inputting the setting information data deleted in step S106 to the simulation device 1 again. However, the optional software deleted in step S104 is not re-added at the point of step S107, and the deleted state is maintained.

In step S108, the option deletion unit 13 further deletes (uninstalls) one of the implemented pieces of optional software. Accordingly, two pieces of optional software are deleted compared with the initial state at the point of step S108.

In step S109, the determination unit 21 determines whether the alarm is cleared in the simulation performed by the simulation unit 11 by deletion of the optional software in step S108. When the alarm is determined to be cleared in step S109, the check processing to be described later is executed; and when the alarm is not determined to be cleared, the processing advances to step S110.

In step S110, the alarm clearance determination processing at setting change described with reference to FIG. 4 is executed. In other words, the determination unit 21 determines whether the alarm is cleared in the simulation performed by the simulation unit 11 by change of setting information data by the setting change unit 12.

When the alarm is determined to be cleared in the simulation performed by the simulation unit 11 through the alarm clearance determination processing at setting registration in step S110, the check processing to be described later is executed.

When the alarm is not determined to be cleared in the simulation performed by the simulation unit 11 through the alarm clearance determination processing at setting registration in step S110, the processing advances to step S111.

In step S111, the option deletion unit 13 determines whether every implemented piece of optional software is deleted. When not every piece of optional software is determined to be deleted in step S111, the processing returns to step S108; and when every piece of optional software is determined to be deleted, the processing is ended.

In step S112, the confirmation unit 22 confirms the setting information data changed when the determination unit 21 determined that the alarm was cleared in step S102 or S106 and/or the optional software deleted when the determination unit 21 determined that the alarm was cleared in step S106 to be the cause of the alarm. Then, the storage unit 23 stores alarm history information associating the setting information data and/or the optional software confirmed to be the cause of the alarm by the confirmation unit 22 with the alarm. The processing is ended after step S112.

When the alarm is determined to be cleared in step S109 or S110, the check processing illustrated in FIG. 5 is executed. The check processing is executed when an alarm is cleared by deletion of a plurality of pieces of optional software.

In the check processing, first, the state of the setting information data and the optional software is returned to the initial state in step S301 by returning the setting information data changed by the setting change unit 12 to the original state and re-adding (installing) the optional software deleted by the option deletion unit 13.

In step S302, the option deletion unit 13 re-deletes the optional software deleted in step S109 when the alarm was determined to be cleared in step S109 or S110.

In step S303, the setting change unit 12 re-changes the setting information data changed in step S110 when the alarm was determined to be cleared in step S110 with the same content of change. When the setting is returned to the original state in step S107, the optional software is deleted in step S108, and the alarm is determined to be cleared in step S109, then the alarm clearance determination processing at setting change in step S110 is not executed; and therefore the processing advances to step S304 without execution of the processing in step S303.

In step S304, the determination unit 21 determines whether the alarm is cleared in the simulation performed by the simulation unit 11.

When the alarm is determined to be cleared in step S304, in step S308, the determination unit 21 confirms the optional software deleted in step S302 and the setting information data changed in step S303 to be the cause of the alarm, and the storage unit 23 stores alarm history information associating the optional software and the setting information data that are confirmed to be the cause of the alarm by the confirmation unit 22 with the alarm. When the setting is returned to the original state in step S107, the optional software is deleted in step S108, the alarm is determined to be cleared in step S109, and the alarm is further determined to be cleared in step S304, then the alarm clearance determination processing at setting change in step S110 is not executed; and therefore, in step S308, the determination unit 21 confirms the optional software deleted in step S302 to be the cause of the alarm, and the storage unit 23 stores alarm history information associating the optional software confirmed to be the cause of the alarm by the confirmation unit 22 with the alarm.

When the alarm is not determined to be cleared in step S304, the option deletion unit 13 further deletes one of the implemented pieces of optional software in step S305.

In step S306, the determination unit 21 determines whether the alarm is cleared in the simulation performed by the simulation unit 11.

When the alarm is determined to be cleared in step S306, the processing returns to step S301.

When the alarm is determined to be cleared in step S306, the option deletion unit 13 determines whether every implemented piece of optional software is deleted in step S307. When not every piece of the optional software is determined to be deleted in step S306, the processing returns to step S305.

When every piece of optional software is determined to be deleted in step S307, in step S308, the confirmation unit 22 confirms the optional software deleted in step S109 to be the cause of the alarm when the alarm was determined to be cleared in step S109 and confirms the setting information data changed in step S110 and the optional software deleted in steps S104 and S108 to be the cause of the alarm when the alarm was determined to be cleared in step S110. The storage unit 23 stores alarm history information associating the optional software and/or the setting information data confirmed to be the cause of the alarm by the confirmation unit 22 with the alarm. Subsequently, the processing is ended.

As an example, a series of processing operations until specification of the cause of an alarm is reached in the simulation device 1 for a robot including three pieces of optional software A, B, and C and two pieces of setting information data a and 3 will be described with several specific examples.

As a first specific example, when, for example, an alarm is determined to be cleared by change of both pieces of the setting information data a and p in step S102, the pieces of setting information data a and p are confirmed to be the cause of the alarm in step S112.

As a second specific example, when, for example, the alarm is not determined to be cleared by change of setting information data in step S102, the setting information data are returned to the state before the change in step S103, and the optional software A is deleted in step S104. When the alarm is determined to be cleared by deletion of the optional software A in step S105, the optional software A is confirmed to be the cause of the alarm in step S112.

As a third specific example, when, for example, the alarm is not determined to be cleared by change of setting information data in step S102, the setting information data are returned to the state before the change in step S103, and the optional software A is deleted in step S104. Then, when the alarm is not determined to be cleared by deletion of the optional software A in step S105, whether the alarm is cleared by change of setting information data is determined in step S106. When the alarm is determined to be cleared by change of the setting information data a in step S105, the optional software A and the setting information data a are confirmed to be the cause of the alarm in step S112.

As a fourth specific example, when, for example, the alarm is not determined to be cleared by change of setting information data in step S102, the setting information data are returned to the state before the change in step S103, and the optional software A is deleted in step S104. Then, when the alarm is not determined to be cleared by deletion of the optional software A in step S105, whether the alarm is cleared by change of setting information data is determined in step S106. When the alarm is not determined to be cleared by change of setting information data in step S105, the setting information data are returned to the state before the change in step S103, and the optional software B is deleted in step S108. When the alarm is determined to be cleared by deletion of the optional software B in step S109, the state of the optional software is returned to the initial state in step S301 by re-adding the deleted pieces of optional software A and B, and the optional software B is deleted in step S302. When the alarm is determined to be cleared by deletion of the optional software B in step S304, the optional software B is confirmed to be the cause of the alarm in step S308.

As a fifth specific example, when, for example, the pieces of optional software A, B, and C are deleted in a stage in which steps up to step S109 are executed, the alarm is not determined to be cleared in step S109, and the alarm is determined to be cleared by change of the setting information data a in step S110, then the state of the setting information data and the optional software is returned to the initial state in step S301 by re-adding the deleted pieces of optional software A, B, and C and returning the setting information data a to the state before the change, the optional software C is deleted in step S302, and the setting information data a are changed in step S303. When the alarm is not determined to be cleared by deletion of the optional software C in step S304, the optional software A is deleted in step S305, and when the alarm is not determined to be cleared by deletion of the optional software A in step S306, the optional software B is deleted in step S305. When the alarm is determined to be cleared by deletion of the optional software B in step S306, the processing returns to step S301, the state of the setting information data and the optional software is returned to the initial state by re-adding the deleted pieces of optional software A, B, and C and returning the setting information data a to the state before the change in step S301, the pieces of optional software B and C are deleted in step S302, and the setting information data a are changed in step S303. When the alarm is determined to be cleared by deletion of the pieces of optional software B and C in step S304, the pieces of optional software B and C and the setting information data a are confirmed to be the cause of the alarm in step S308.

As a sixth specific example, when, for example, the pieces of optional software A and B are deleted in a stage in which steps up to step S109 are executed, the alarm is not determined to be cleared in step S109, and the alarm is not determined to be cleared by change of setting information data in step S110, then whether every piece of optional software is deleted is determined in step S111. When the optional software C is not deleted in the stage of step S111, the processing returns to step S108, and the optional software C is deleted. When the alarm is still not determined to be cleared by deletion of the pieces of optional software A, B, and C in step S109, the processing advances to step S110; and when the alarm is not determined to be cleared by change of setting information data in step S110, the processing advances to step S111. Every piece of optional software A, B, and C is deleted in this stage, and therefore the processing is ended with the cause of the alarm being unspecifiable.

The simulation device 1 described above is configured with a computer including an arithmetic processing unit (processor). The arithmetic processing unit includes the simulation unit 11, the setting change unit 12, the option deletion unit 13, and the alarm cause specification unit 14. For example, each unit included in the arithmetic processing unit is a function module provided by a computer program executed on the processor. For example, when the simulation unit 11, the setting change unit 12, the option deletion unit 13, and the alarm cause specification unit 14 are constructed in a computer program format, the function of each unit can be provided by causing the arithmetic processing unit to operate in accordance with the computer program. A computer program for executing processing in each of the simulation unit 11, the setting change unit 12, the option deletion unit 13, and the alarm cause specification unit 14 may be provided in a form of being recorded on a computer-readable recording medium such as a semiconductor memory, a magnetic recording medium, or an optical recording medium. Alternatively, the simulation unit 11, the setting change unit 12, the option deletion unit 13, and the alarm cause specification unit 14 may be provided as a semiconductor integrated circuit in which a computer program providing the functions of the units is written.

The embodiment of the present disclosure enables easy clearance of an alarm in a simulation device for a robot or a machine tool and further enables easy specification of the cause of the alarm.

While a case of the simulation 1 being a robot simulation device performing a simulation of the operation of a robot has been described above, the aforementioned description is similarly applicable to a machine tool simulation device performing a simulation of the operation of a machine tool.

### REFERENCE SIGNS LIST

1 Simulation device
11 Simulation unit
12 Setting change unit
13 Option deletion unit
14 Alarm cause specification unit
21 Determination unit
22 Confirmation unit
23 Storage unit
31 Keyboard
32 Mouse
33 Display device

1. A simulation device comprising:
a simulation unit configured to perform a simulation of operation of a robot or a machine tool;
a setting change unit configured to change setting information data used when operation of the robot or the machine tool is controlled, when an alarm indicating abnormal operation of the robot or the machine tool is issued in a simulation performed by the simulation unit; and
an option deletion unit configured to delete optional software used when an optional function in operation of the robot or the machine tool is controlled, when the alarm is issued.

2. The simulation device according to claim 1, further comprising
an alarm cause specification unit configured to specify a cause of the alarm, based on a content of change of the setting information data by the setting change unit and/or a content of deletion of the optional software by the option deletion unit.

3. The simulation device according to claim 2, wherein
the alarm cause specification unit includes:
a determination unit configured to determine whether the alarm is cleared at change of the setting information data by the setting change unit and/or deletion of the optional software by the option deletion unit; and
a confirmation unit configured to confirm setting information data changed when the determination unit determines that the alarm is cleared and/or optional software deleted when the determination unit determines that the alarm is cleared to be a cause of the alarm.

4. The simulation device according to claim 3, wherein
the alarm cause specification unit includes a storage unit configured to store alarm history information associating setting information data and/or optional software confirmed to be a cause of the alarm by the confirmation unit with the alarm.

5. The simulation device according to claim 4, wherein
the setting change unit changes setting information data related to the alarm with reference to past alarm history information stored in the storage unit, when an alarm is issued in a simulation performed by the simulation unit, and
the option deletion unit deletes optional software related to the alarm with reference to past alarm history information stored in the storage unit, when an alarm is issued in a simulation performed by the simulation unit.

6. The simulation device according to claim 3, wherein,
when the setting change unit changes setting information data with issuance of an alarm in a simulation performed by the simulation unit and the determination unit still does not determine that the alarm is cleared, the option deletion unit deletes optional software, and,
when the option deletion unit deletes the optional software and the determination unit still does not determine that the alarm is cleared, the setting change unit further changes setting information data.

7. The simulation device according to claim 3, wherein,
when the option deletion unit deletes first optional software, the determination unit does not determine that the alarm is cleared, the option deletion unit subsequently further deletes second optional software, and the determination unit determines that the alarm is cleared, then the option deletion unit deletes the second optional software again from a state in which the first optional software and the second optional software are re-added, and
the determination unit determines whether the alarm is cleared by deletion of the second optional software by the option deletion unit.
